(19) United States
(12) Patent Application Publication
(10) Pub. No.: US 2023/0072161 A1
(43) Pub. Date: Mar. 9, 2023

(54) Method of display control and related display driver circuit and application processor

(71) Applicant: NOVATEK Microelectronics Corp., Hsin-Chu (TW)

(72) Inventors: Yu-Ju Lin, Hsinchu County (TW); Kai-Wen Shao, Hsinchu City (TW); Yao-Min Chou, Hsinchu City (TW)

(73) Assignee: NOVATEK Microelectronics Corp., Hsin-Chu (TW)

(21) Appl. No.: 17/468,647

(22) Filed: Sep. 7, 2021

(51) Int. Cl. G09G 3/20

(52) U.S. Cl. CPC G09G 3/20; G09G 2310/061; G09G 2340/16

(57) ABSTRACT

The present invention provides a method of display control for a display driver circuit operated in a video mode. The method includes steps of: driving a display panel to display a plurality of image frames having a plurality of active frames and a plurality of blanking frames, and determining whether to transmit a notification to an application processor to indicate whether the application processor needs to output image data according to whether an incoming image frame among the plurality of image frames is one of the plurality of active frames or one of the plurality of blanking frames. Wherein, the display panel is refreshed in each of the plurality of active frames, and not refreshed in each of the plurality of blanking frames.

### BACKGROUND OF THE INVENTION

### 1. Field of the Invention

The present invention relates to a method of display control for a display driver circuit and an application processor, and more particularly, to a method of display control based on communications between a display driver circuit and an application processor.

### 2. Description of the Prior Art

Modern organic light-emitting diode (OLED) panels in the market mostly apply the low-temperature polycrystalline silicon (LTPS) technology, where the substrate of the OLED panels is composed of polycrystalline silicon synthesized at relatively low temperatures as compared to traditional manufacturing methods. The low-temperature polycrystalline oxide (LTPO) technology is an evolution of the LTPS. In an LTPO panel, an additional oxide layer is inserted on the substrate, allowing the electrons to pass through the thin-film transistors (TFTs) implemented on the substrate more rapidly and efficiently, reducing the power required to activate the display pixels, so as to reduce the overall power consumption.

The display of the LTPO panel supports an extremely low frame rate such as 1 Hz. In the LTPO panel, the low frame rate may be realized by refreshing several image frames and not refreshing several image frames to be displayed on the panel. For example, in a display architecture having 60 Hz frame rate, the LTPO panel may be refreshed in one of every 60 frames, and may omit the refreshing in other 59 frames, so as to achieve the 1 Hz frame rate equivalently.

In a display system, the display panel may be controlled by a display driver circuit, and the image data are provided from an application processor (AP) and forwarded through the display driver circuit. The LTPO panel may enter an operation mode having a low frame rate through a display sequence when the AP does not need to update the images. In this low frame rate mode, the LTPO panel should be accurately controlled to be refreshed in one or several frames and not refreshed in other frames periodically, in order to realize the low frame rate. In such a situation, the display driver circuit and the AP should provide the image data appropriately based on the refreshing scheme of the panel.

In general, the display driver circuit and the AP may perform display control in a video mode or a command mode. In the command mode, the display control circuit is equipped with a frame buffer which may be implemented with a random-access memory (RAM). The AP sends instructions in addition to the image data to the display driver circuit, and the image data are written into the frame buffer through the control of the instructions. As for an LTPO panel operated in a low frame rate mode, the AP may output the image data at any time before the image data is requested to be sent to the panel, and the image data may be stored in the frame buffer. When the LTPO panel needs to be refreshed, the display driver circuit may read out the image data from the frame buffer.

In the video mode, the AP provides the image data in the form of a real-time data stream. The display driver circuit correspondingly processes the data stream and directly forwards it to the panel. Thus, in order to reduce the cost and complexity, there may be no frame buffer implemented in the display driver circuit. When the panel needs to be refreshed, the AP should output the image data immediately. As for an LTPO panel operated in a low frame rate mode, the image may not be refreshed in most image frames; hence, the AP does not need to output image data for these image frames.

However, the display sequence of the LTPO panel is configured in the display driver circuit, but the AP does not know any information associated with the display sequence. Therefore, when the LTPO panel is operated in the low frame rate mode and meanwhile the display system applies the video mode and the display driver circuit has no frame memory, the AP may not know when to output image data. Thus, there is a need for improvement over the prior art.

### SUMMARY OF THE INVENTION

It is therefore an objective of the present invention to provide a novel display control method applicable to the display driver circuit and the application processor, allowing the display driver circuit and the application processor to communicate with each other to satisfy the low frame rate application of the low-temperature polycrystalline oxide (LTPO) panel.

An embodiment of the present invention discloses a method of display control for a display driver circuit. The display driver circuit is operated in a video mode. The method comprises steps of: driving a display panel to display a plurality of image frames having a plurality of active frames and a plurality of blanking frames; and determining whether to transmit a notification to an application processor to indicate whether the application processor needs to output image data according to whether an incoming image frame among the plurality of image frames is one of the plurality of active frames or one of the plurality of blanking frames. Wherein, the display panel is refreshed in each of the plurality of active frames, and not refreshed in each of the plurality of blanking frames.

Another embodiment of the present invention discloses a display driver circuit, which is configured to be coupled to an application processor and a display panel. The display driver circuit is operated in a video mode, and configured to drive the display panel to display a plurality of image frames having a plurality of active frames and a plurality of blanking frames; and determine whether to transmit a notification to the application processor to indicate whether the application processor needs to output image data according to whether an incoming image frame is one of the plurality of active frames or one of the plurality of blanking frames. Wherein, the display panel is refreshed in each of the plurality of active frames, and not refreshed in each of the plurality of blanking frames.

Another embodiment of the present invention discloses a method of display control for an application processor. The application processor is configured to control a display driver circuit operated in a video mode. The method comprises steps of: providing a plurality of image frames for the display driver circuit to be displayed on a display panel; outputting first image data for a first image frame among the plurality of image frames to the display driver circuit; and after outputting the first image data, determining whether to transmit a command to the display driver circuit for a second image frame among the plurality of image frames, to indicate whether the application processor is configured to proactively output second image data for the second image frame.

Another embodiment of the present invention discloses an application processor, which is configured to be coupled to a display driver circuit and a display panel. The display driver circuit is operated in a video mode. The application processor is configured to provide a plurality of image frames for the display driver circuit to be displayed on the display panel; output first image data for a first image frame among the plurality of image frames to the display driver circuit; and after the first image data are output, determine whether to transmit a command to the display driver circuit for a second image frame among the plurality of image frames, to indicate whether the application processor is configured to proactively output second image data for the second image frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display sequence of a display panel.

FIGS. 2A-2D are schematic diagrams of display systems according to embodiments of the present invention.

FIG. 3 is a schematic diagram of a state machine corresponding to the display sequence.

FIG. 4 is a flowchart of a display control process according to an embodiment of the present invention.

FIG. 5 is a timing diagram of the display sequence and related control operations.

FIG. 6 is a flowchart of a display control process according to an embodiment of the present invention.

FIGS. 7-11 are timing diagrams of the display sequence and related control operations according to embodiments of the present invention.

### DETAILED DESCRIPTION

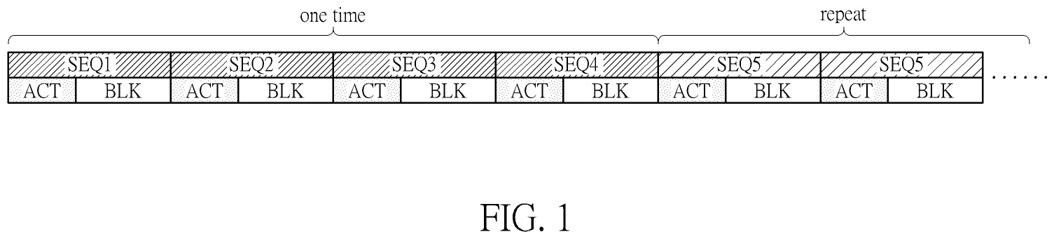

Please refer to FIG. 1, which is a schematic diagram of a display sequence of a display panel. The display sequence, which includes several skip sequences SEQ1-SEQ5, may be applicable to a low-temperature polycrystalline oxide (LTPO) panel for realizing the extremely low frame rate. If the LTPO panel enters a low frame rate mode, the display operation may go through the skip sequences SEQ1-SEQ4 by one time, and then repeatedly perform the skip sequence SEQ5. The transitional skip sequences SEQ1-SEQ4 allow the image to be shown more smoothly when the panel enters the low frame rate mode from the normal display mode. That is, the frame rate may be decreased gradually from the skip sequence SEQ1 to the skip sequence SEQ5. Since the refresh of several image frames are skipped in the low frame rate mode, it will be called “skip mode” hereinafter.

In detail, each skip sequence SEQ1-SEQ5 may have one or more active frames (ACT) and one or more blanking frames (BLK). The panel is refreshed in the active frame(s) and is not refreshed in the blanking frame(s). If the frame rate equals 60 Hz in the normal display mode, in order to realize the extremely low frame rate such as 1 Hz, there may be 1 active frame and 59 blanking frames in the repeated skip sequence SEQ5. In other words, the panel may be refreshed in only one of every 60 image frames as the skip sequence SEQ5 is performed repeatedly.

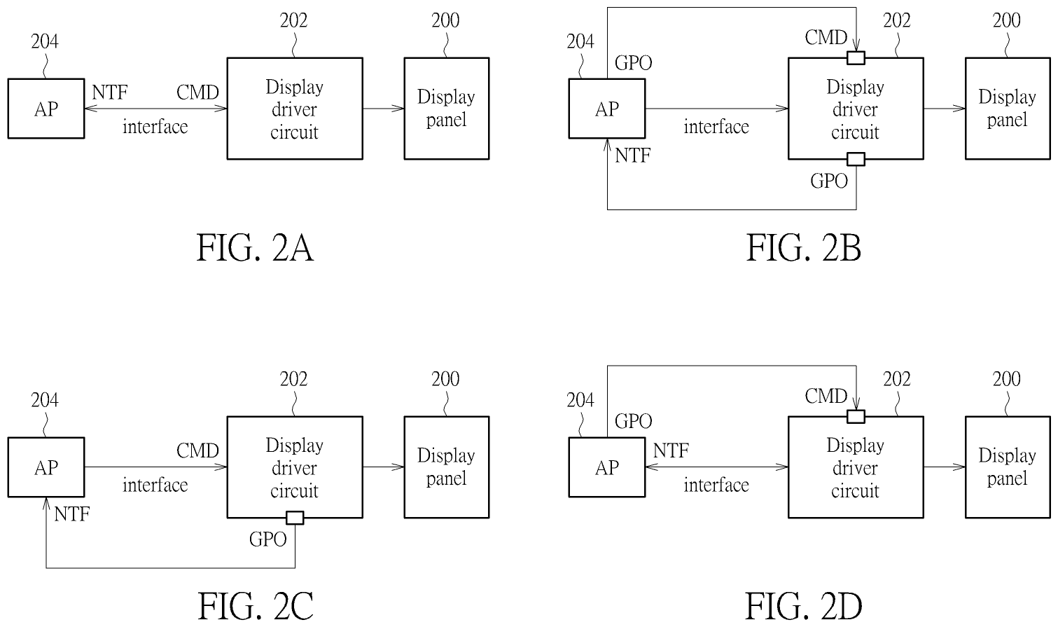

Please refer to FIGS. 2A-2D, which are schematic diagrams of display systems according to embodiments of the present invention. As shown in FIGS. 2A-2D, each display system includes a display panel 200, a display driver circuit 202 and an application processor (AP) 204, where the display driver circuit 202 is coupled between the display panel 200 and the AP 204. The display panel 200 may be any type of display device such as an LTPO panel, which is configured with the skip mode to realize the extremely low frame rate. The display driver circuit 202 is configured to drive the display panel 200 to display an image. Since the display panel 200 is an LTPO panel supporting the skip mode where only several image frames are refreshed, the display driver circuit 202 is capable of controlling the flow of the skip sequences, so as to control the refreshing operations of the display panel 200. The AP 204 is configured to provide the image data to be displayed on the display panel 200. In detail, the AP 204 may output the image data to the display driver circuit 202, and then the display driver circuit 202 may process the image data and convert the image data to a voltage signal to be delivered to the display panel 200.

In an embodiment, the display driver circuit 202 may be implemented in an integrated circuit (IC) to be realized as a display driver IC. In addition, the display driver IC may be integrated with touch sensing functions to realize a touch and display driver IC (TDDI), or further integrated with fingerprint sensing functions to realize a fingerprint, touch and display driver IC (FTDI). The AP 200 may be, but not limited to, a central processing unit (CPU), microprocessor, microcontroller unit (MCU), or any other type of processing circuit of an electronic device. In the embodiments of the present invention, the display system may be operated in the video mode, where there is no frame buffer included in the display driver circuit 202, and the AP 204 should output the image data when the display panel 200 needs to be refreshed.

Please note that the display sequence of the LTPO panel is configured in the display driver circuit 202; that is, the display driver circuit 202 may control the flow of the skip sequences with configurations of the active frames and the blanking frames. In the prior art, the AP 204 may not know when to output image data in the video mode because it is not aware of the information of the skip sequences. In order to solve this problem, the display driver circuit 202 may transmit a notification to the AP 204, to indicate whether the AP 204 needs to output image data according to whether an incoming image frame is the active frame or the blanking frame. In other words, the notification may carry the information associated with the active frame and the blanking frame, and thus the AP 204 will output the image data only when the notification indicates that the incoming image frame is the active frame.

Sometimes the AP 204 may need to proactively output image data. For example, the AP 204 may need to update the image content when the user activates a specific event to modify the displayed image. In such a situation, the AP 204 may transmit a command to the display driver circuit 202, to indicate whether the AP 204 needs to proactively output the image data, i.e., update the image content.

As can be seen, the display panel 200 is driven by the display driver circuit 202 while the image data are output from the AP 204. The present invention provides a communication scheme that allows the display driver circuit 202 and the AP 204 to negotiate with each other to appropriately output image data, so as to successfully control the panel refresh in the extremely low frame rate when the display system and the display driver circuit 202 are operated in the video mode.

In general, the AP 204 may deliver the image data to the display driver circuit 202 through a transmission interface. Examples of the transmission interface may include, but not limited to, the Mobile Industry Processor Interface (MIPI), Serial Peripheral Interface (SPI), and Inter-Integrated Circuit (I2C) interface. This transmission interface may usually be a bidirectional interface. In an embodiment, the display driver circuit 202 and the AP 204 may communicate with each other through this interface used for delivering the image data, as shown in FIG. 2A. The display driver circuit 202 may transmit a notification NTF to the AP 204, to indicate whether the incoming image frame is the active frame or the blanking frame. The AP 204 may transmit a command CMD to the display driver circuit 202, to indicate whether the AP 204 needs to proactively output the image data.

In another embodiment, the notification NTF and the command CMD may be transmitted in another manner. For example, as shown in FIG. 2B, the display driver circuit 202 may transmit a notification NTF to the AP 204 through a general purpose output (GPO) pin of the display driver circuit 202, and the AP 204 may transmit a command CMD to the display driver circuit 202 through a GPO pin of the AP 204.

When the notification NTF and/or the command CMD are sent through the interface for delivering image data, the notification NTF and/or the command CMD may be carried in the blanking interval in which no valid image data are transmitted. For example, the command CMD may be carried in a front porch or a back porch in the image data format, and/or may be indicated in a horizontal synchronization start (HSS) packet, a vertical synchronization start (VSS) packet, or a vertical synchronization end (VSE) packet.

In another embodiment, the display driver circuit 202 may transmit a notification NTF to the AP 204 through the GPO pin of the display driver circuit 202, while the AP 204 may transmit a command CMD to the display driver circuit 202 through the interface for delivering image data, as shown in FIG. 2C. Alternatively, the display driver circuit 202 may transmit a notification NTF to the AP 204 through the interface for delivering image data, while the AP 204 may transmit a command CMD to the display driver circuit 202 through the GPO pin of the AP 204, as shown in FIG. 2D.

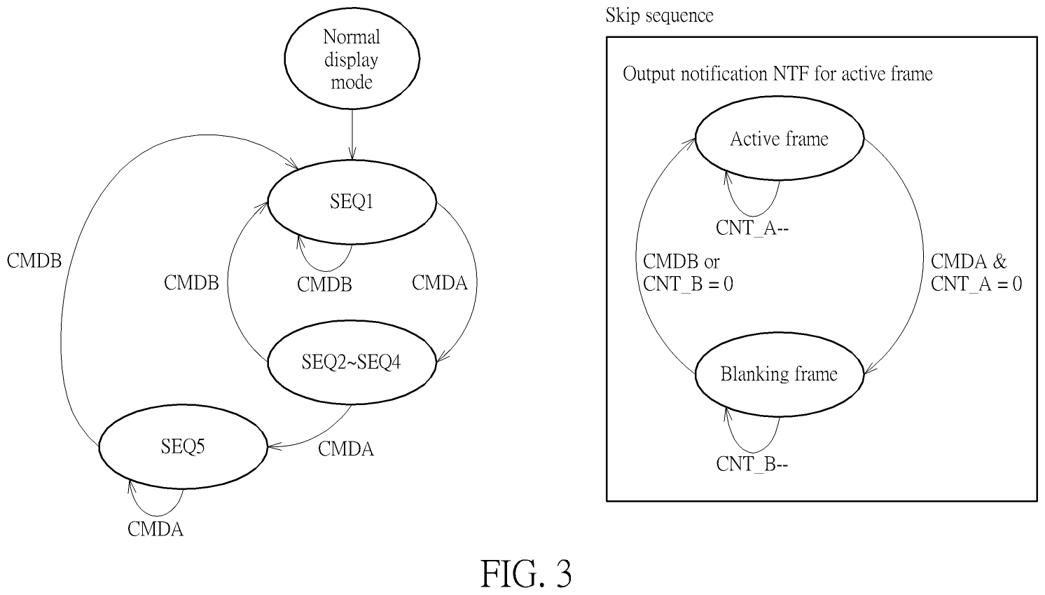

Please refer to FIG. 3, which is a schematic diagram of a state machine corresponding to the display sequence. As shown in FIG. 3, the display sequence may start with the skip sequence SEQ1 when entering the skip mode from the normal display mode. If the AP 204 does not proactively output image data, the display sequence may go through the skip sequences SEQ1-SEQ4 and then stay in the skip sequence SEQ5 (i.e., perform the skip sequence SEQ5 repeatedly). If the AP 204 needs to proactively output image data, the display sequence may return to the skip sequence SEQ1 no matter the sequence is in which state. Referring to FIG. 3 with reference to FIGS. 2A-2D, the AP 204 may transmit a command CMD to the display driver circuit 202, and the command CMD indicates whether the AP 204 needs to proactively output the image data. In this embodiment, the AP 204 is capable of transmitting two different types of commands CMDA and CMDB. The AP 204 may transmit the command CMDB when it needs to proactively output the image data, and transmit the command CMDA when it does not need to proactively output the image data. Therefore, when receiving the command CMDB, the display driver circuit 202 may control the display sequence to return to the skip sequence SEQ1. When receiving the command CMDA, the display driver circuit 202 may go through the skip sequences based on the predetermined configuration.

Each skip sequence SEQ1-SEQ5 includes one or more active frames and one or more blanking frames. The arrangements of the active frames and the blanking frames are also shown in FIG. 3. In an embodiment, a counter CNT_A may be allocated to the active frame, and a counter CNT_B may be allocated to the blanking frame, in order to control the display sequence based on the counters. The values of the counters CNT_A and CNT_B, which refer to the number of active frame(s) and the number of blanking frame (s) in the skip sequence, respectively, may be predetermined based on the configurations of the display sequence. The counter value may be subtracted by 1 in each image frame, and the flow goes to another type of frame when the corresponding counter reaches 0. In detail, when the current image frame is the active frame, the next image frame will be the blanking frame if the counter CNT_A reaches 0. When the current image frame is the blanking frame, the next image frame will be the active frame (of a subsequent skip sequence) if the counter CNT_B reaches 0. In addition, if the command CMDB indicating that the AP 204 needs to proactively output image data is received, the next image frame will be the active frame (of the skip sequence SEQ1) regardless of the present counter value.

As mentioned above, the display driver circuit 202 may transmit the notification NTF to the AP 204, to indicate whether the incoming image frame is the active frame or the blanking frame. In this embodiment as shown in FIG. 3, the display driver circuit 202 may output the notification NTF for each active frame, and may not output any notification NTF for each blanking frame. Therefore, the notification NTF may be output when the current image frame is the active frame and the counter CNT_A is greater than 0 (which indicate that the next image frame is still the active frame), and when the current image frame is the blanking frame and the counter CNT_B is 0 (which indicate that the next image frame will be changed to the active frame). Based on the number of active frames and the number of blanking frames in each skip sequence, the configurations of the counters CNT_A and CNT_B may be determined, and the display driver circuit 202 may output the notification NTF based on the values of the counters CNT_A and CNT_B, in order to instruct the AP 204 to output image data at an appropriate time point.

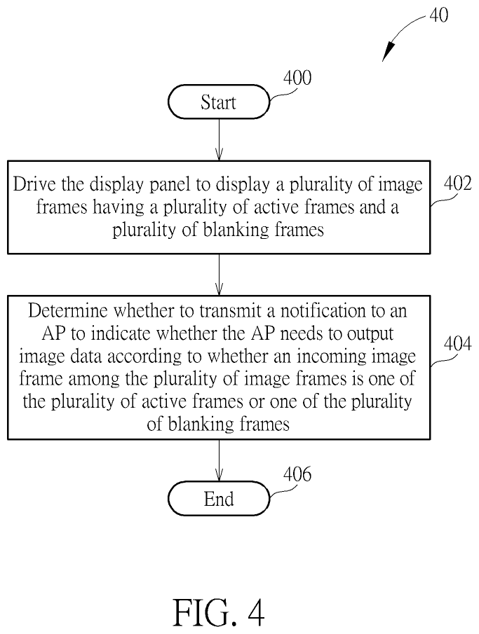

Please refer to FIG. 4, which is a flowchart of a display control process 40 according to an embodiment of the present invention. The display control process 40 may be realized in a display driver circuit used to drive a display panel for display, such as the display driver circuit 202 shown in any of FIGS. 2A-2D. As shown in FIG. 4, the display control process 40 includes the following steps:

Step 400: Start.

Step 402: Drive the display panel to display a plurality of image frames having a plurality of active frames and a plurality of blanking frames.

Step 404: Determine whether to transmit a notification to an AP to indicate whether the AP needs to output image data according to whether an incoming image frame among the plurality of image frames is one of the plurality of active frames or one of the plurality of blanking frames.

Step 406: End.

According to the display control process 40, the display driver circuit may drive the display panel to display image frames, which consist of the active frames and the blanking frames in the skip mode, where the display panel is refreshed in the active frame and is not refreshed in the blanking frame. In this embodiment, the display driver circuit is operated in the video mode and deployed with no frame memory; hence, the AP may output image data only when the display panel needs to refresh the image frames (i.e., the active frames). The display driver circuit thereby determines whether to transmit the notification to the AP, to indicate whether the AP needs to output the image data according to whether the incoming image frame is the active frame or the blanking frame.

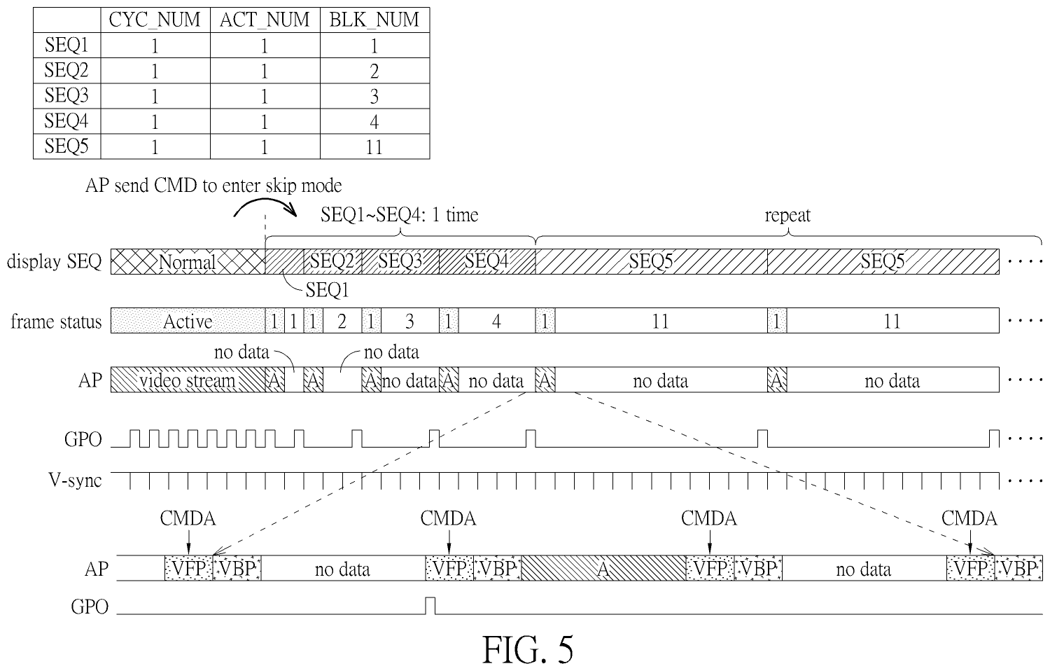

A detailed implementation of the display control process 40 is illustrated in FIG. 5, which is a timing diagram of the display sequence and related control operations. In FIG. 5, the display mode and the display sequence, the status of image frames, the output behavior of the AP, the signal on the GPO pin of the display driver circuit, and the vertical synchronization (V-sync) signal are illustrated. Each pulse of the vertical synchronization signal indicates the start of one image frame. In the beginning, the display system operates in the normal display mode. In the normal display mode, the display panel refreshes all image frames, and thus all the image frames may be considered as the active frames. The AP continuously outputs a video stream and the GPO pin keeps toggling in the normal display mode.

Subsequently, when the display system determines to enter the skip mode, the AP may send a command to the display driver circuit. Upon receiving this command, the display driver circuit may start the display sequence in the skip mode consisting of the skip sequences SEQ1-SEQ5, to go through the skip sequences SEQ1-SEQ4 by one time and then repeatedly perform the skip sequence SEQ5. The table in FIG. 5 shows the configurations of the skip sequences SEQ1-SEQ5. The field CYC_NUM indicates whether each skip sequence SEQ1-SEQ5 is valid. The value “1” for the skip sequences SEQ1-SEQ5 means that every skip sequence SEQ1-SEQ5 is valid and performed in the skip mode. The fields of frame counts ACT_NUM and BLK_NUM respectively specify the number of active frames and the number of blanking frames in each skip sequence SEQ1-SEQ5. For example, the skip sequence SEQ1 includes 1 active frame and 1 blanking frame, the skip sequence SEQ2 includes 1 active frame and 2 blanking frames, and so on. In the skip sequence SEQ5, only one image frame is refreshed among every 12 image frames, so as to achieve the extremely low frame rate.

The display driver circuit may determine whether to transmit the notification to the AP to indicate whether the incoming image frame is the active frame or the blanking frame through the GPO pin. Note that the display panel is refreshed in the active frame and is not refreshed in the blanking frame; hence, the notification may indicate whether the display panel needs to be refreshed in the incoming image frame. In an embodiment, the display driver circuit may transmit a notification when the incoming image frame is the active frame, and stop transmitting the notification when the incoming image frame is the blanking frame. The notification may be realized as a toggle or a pulse on the GPO pin. As shown in FIG. 5, the GPO pin toggles in the image frame previous to each active frame, and stops toggling in the image frame previous to each blanking frame. In other words, the toggle on the GPO pin indicates that the next frame will be the active frame. The AP thereby outputs image data for the active frames and stops outputting image data for the blanking frames based on the received notification. In this manner, the operations of the AP and the display driver circuit will be well synchronized.

In this embodiment, the AP outputs the image data A for each active frame, which means that the AP does not proactively update the image data and thus the same image data A are continuously output. Correspondingly, the AP may transmit the command CMDA for each image frame, to indicate that the image data need not to be updated. In detail, the AP may transmit the command CMDA in the vertical front porch (VFP) of the previous frame, to indicate that the image data output in the current frame are identical to those image data previously output (i.e., the image data A), or indicate that there are no image data output in the current frame.

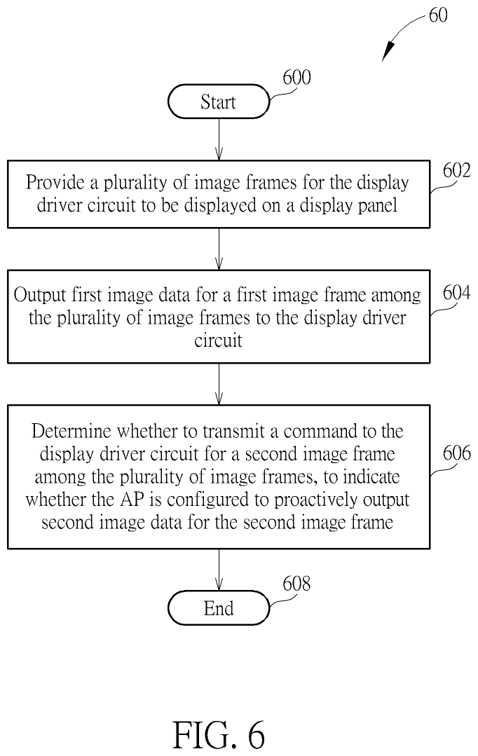

Please refer to FIG. 6, which is a flowchart of a display control process 60 according to an embodiment of the present invention. The display control process 60 may be realized in an AP used to control a display driver circuit, such as the AP 204 shown in any of FIGS. 2A-2D. As shown in FIG. 6, the display control process 60 includes the following steps:

Step 600: Start.

Step 602: Provide a plurality of image frames for the display driver circuit to be displayed on a display panel.

Step 604: Output first image data for a first image frame among the plurality of image frames to the display driver circuit.

Step 606: Determine whether to transmit a command to the display driver circuit for a second image frame among the plurality of image frames, to indicate whether the AP is configured to proactively output second image data for the second image frame.

Step 608: End.

According to the display control process 60, the AP may determine whether to transmit a command to the display driver circuit, to indicate whether the AP needs to proactively output the image data. More specifically, when the AP needs to update the image data, the AP may transmit the command correspondingly. In the above embodiment shown in FIG. 5, the AP transmits the command CMDA to the display driver circuit when outputting identical image data or not outputting any image data. When the AP needs to output image data different from the previous one, i.e., needs to update the image data, the AP may transmit another type of command such as the command CMDB.

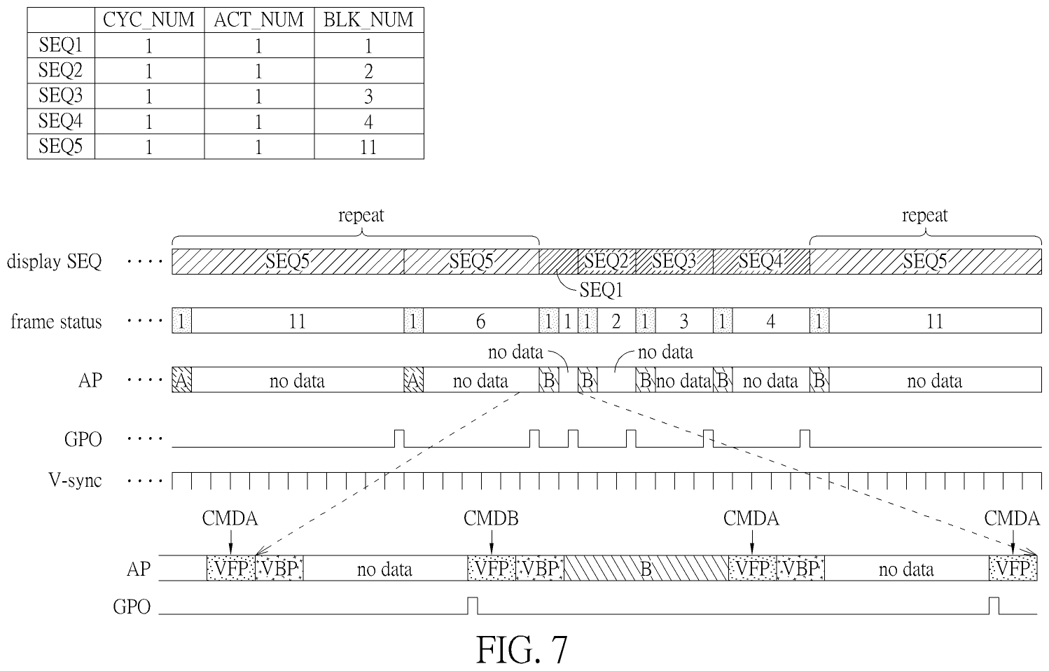

Please refer to FIG. 7, which is a timing diagram of the display sequence and related control operations. Similarly, the display mode and the display sequence, the status of image frames, the output behavior of the AP, the signal on the GPO pin of the display driver circuit, and the vertical synchronization (V-sync) signal are illustrated in FIG. 7. In this embodiment, the AP may output the first image data A for the active frames in the skip mode, and correspondingly transmit the command CMDA. When the AP needs to proactively update the image content and output the second image data B which are different from the first image data A, the AP transmits the command CMDB different from the command CMDA. For example, if the user activates a specific event to modify the image content, the displayed image should be updated immediately. In such a situation, the AP may send the command CMDB to the display driver circuit, to notify the display driver circuit that the AP will proactively update the image data.

As shown in FIG. 7, the command CMDB is transmitted in the VFP of an image frame, which indicates that the AP will send new image data (i.e., the image data B) in the next image frame. The AP transmits the command CMDA if the original image data A is output or no image data is output. Therefore, the display driver circuit will know when the AP needs to proactive output the new image data based on the received command. Reception of the command CMDA means that the AP may not output any image data or may output the original image data A in response to the notification of the display driver circuit in the skip sequence. Reception of the command CMDB means that the AP may proactively output the new image data B. In response to the command CMDB and the updated image data, the present skip sequence may be interrupted, and the flow of the skip mode will return to the skip sequence SEQ1, regardless of the present frame status of skip sequence. For example, as shown in FIG. 7, although the display sequence is in the 6^{th} blanking frame of the skip sequence SEQ5 which totally has 11 blanking frames, the display driver circuit will interrupt the present skip sequence SEQ5 and set the next image frame to be the 1^{st} active frame of the skip sequence SEQ1 when receiving the command CMDB, where the AP correspondingly outputs the updated image data B. The display sequence thereby performs a new flow starting from an active frame of the skip sequence SEQ1, and goes through the skip sequences SEQ2-SEQ4 and then repeats the skip sequence SEQ5 in the same manner, until the next command CMDB is received.

Please note that the present invention aims at providing a novel display control method applicable to the display driver circuit and the AP. Those skilled in the art may make modifications and alterations accordingly. For example, the numbers of active frames and blanking frames in each skip sequence may be configured flexibly. In an embodiment, the numbers of active frames and blanking frames may be configured based on the display characteristics of the panel, and/or based on the frame rate value to be achieved in the skip mode. The frame counts ACT_NUM and BLK_NUM recorded in the tables in the above embodiments are merely served to illustrate an example, and this should not be a limitation of the scope of the present invention. In addition, the number of transitional skip sequences may also be configured flexibly. Also, the embodiments of the present invention are applicable to any types of display panels capable of realizing the extremely low frame rate by refreshing partial image frames. These types of display panels may include, but not limited to, the LTPO panel.

Further, in the above embodiments, the command sent by the AP for the current image frame is carried in the VFP of the previous image frame, but the implementation of the command transmission is not limited thereto. As shown in the zoom-in diagrams of FIGS. 5 and 7, the image or video transmission format of a frame includes an image data area, a VFP after the image data area, and a vertical back porch (VBP) before the image data area. Therefore, the command for the current image frame may be carried in the VFP of the previous image frame or the VBP of the current image frame, as long as the display driver circuit can receive the command and control the display sequence in time. Similarly, in the above embodiments, the notification sent by the display driver circuit for the current image frame (e.g., the active frame), as a toggle or a pulse on the GPO pin, is synchronous to the VFP of the previous image frame. In another embodiment, this notification may also be synchronous to the image data area of the previous image frame, the VBP of the current image frame, or any other feasible position.

In another embodiment, the notification sent by the display driver circuit may be transmitted through the interface for delivering image data, to be carried in the VBP, VFP, or any other blanking interval. In addition, the display driver circuit may provide different types of notifications for the active frame and the blanking frame. For example, the display driver circuit may transmit a first notification to the AP if the incoming image frame is the active frame, and transmit a second notification different from the first notification to the AP if the incoming image frame is the blanking frame. The AP thereby determines whether to output image data by recognizing the received notification.

Similarly, although the commands sent by the AP are transmitted through the interface for delivering image data in the embodiments shown in FIGS. 5 and 7, they may also be transmitted through the GPO pin or delivered to the display driver circuit in any other possible manner.

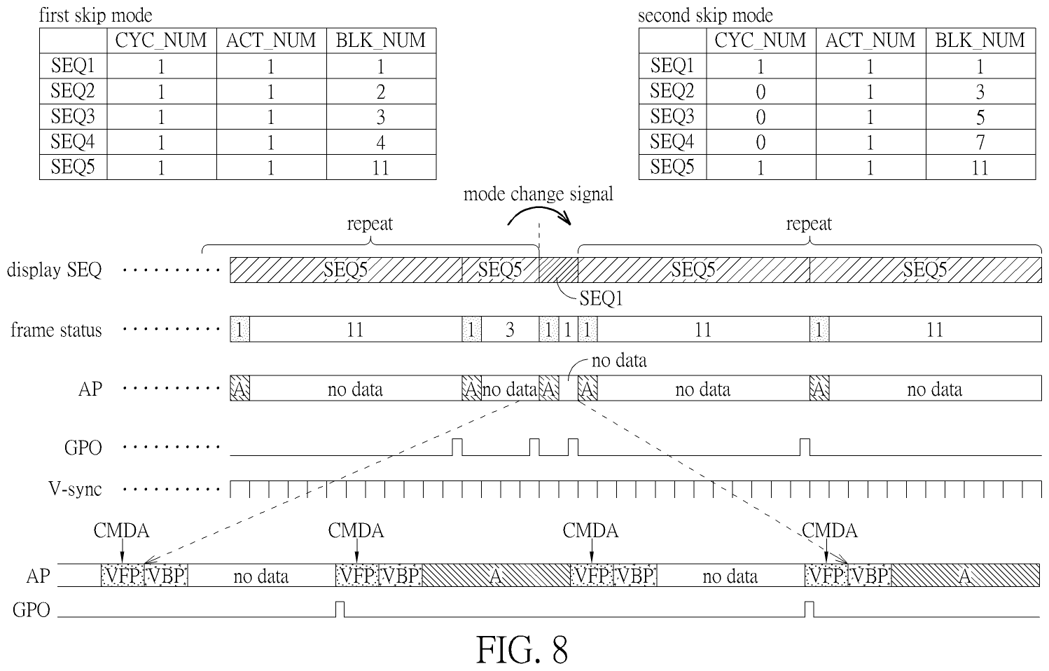

FIG. 8 illustrates another timing diagram of the display sequence according to an embodiment of the present invention. In this embodiment, the display panel is configured with multiple different skip modes, which may have different configurations of skip sequences. As mentioned above, the numbers of active frames and blanking frames in each skip sequence may be configured flexibly. The configurations of the display sequence may be customized based on system requirements. The allocations of different skip modes having different skip sequence configurations can facilitate the customization.

As shown in FIG. 8, the display panel may be configured with a first skip mode and a second skip mode. The AP may transmit a mode change signal to the display driver circuit. The display driver circuit may control the skip mode of the display panel and the corresponding skip sequences based on the received mode change signal. For example, the display panel is in the first skip mode originally. When the mode change signal is received, the display driver circuit may interrupt the present skip sequence of the first skip mode, and start the flow of the skip sequences of the second skip mode. In the second skip mode, the value “1” for the skip sequences SEQ1 and SEQ5 means that the skip sequences SEQ1 and SEQ5 are valid, and the value “0” for the skip sequences SEQ2-SEQ4 means that the skip sequences SEQ2-SEQ4 are invalid. In other words, in the second skip mode, the display operation may go through the skip sequence SEQ1 by one time, and then repeatedly perform the skip sequence SEQ5, where the skip sequences SEQ2-SEQ4 are omitted.

In an embodiment, the display panel such as an LTPO panel may be configured with multiple low frame rates, which may be applicable to different scenarios. Therefore, different applications may use different skip modes so as to achieve different frame rates. For example, the frame rate may be decreased to 10 Hz in the first skip mode and 5 Hz in the second skip mode. The display panel will enter the first skip mode when an application requesting 10 Hz frame rate is open, and enter the second skip mode when another application requesting 5 Hz frame rate is open. Therefore, in the display system of the present invention, the display panel may be configured with any number of skip modes, and switched between the skip modes flexibly based on the control of the AP. The AP may transmit the mode change signal to notify the display driver circuit to change the skip mode. In an embodiment, the mode change signal may carry information indicating which skip mode the display panel will enter, and the display driver circuit may control the display sequence correspondingly.

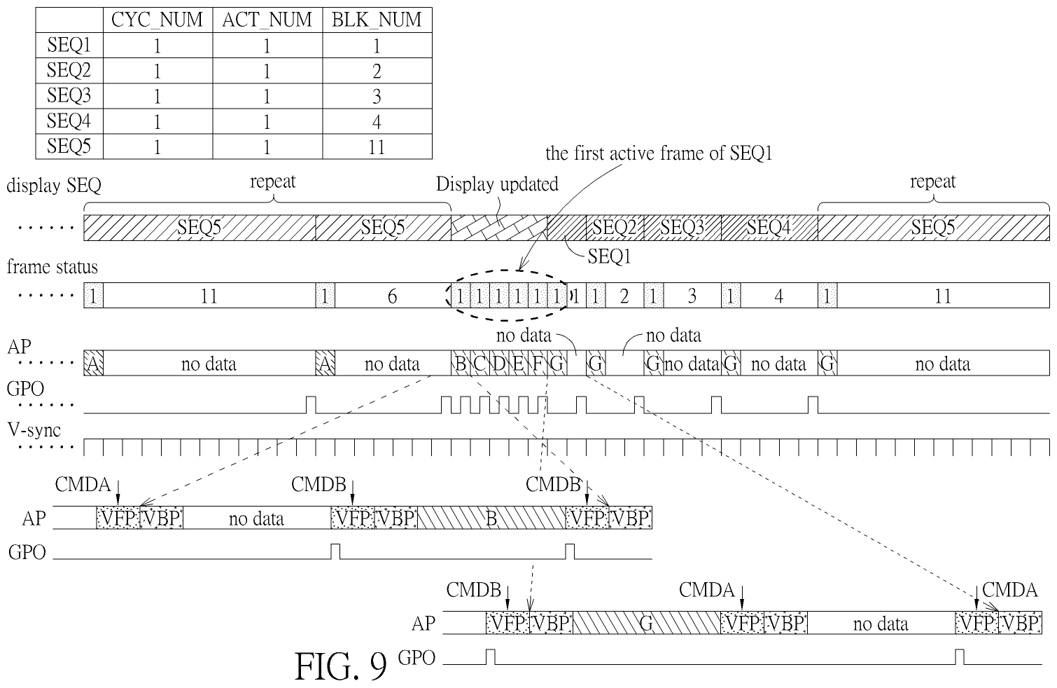

FIG. 9 illustrates a further timing diagram of the display sequence according to an embodiment of the present invention. In this embodiment, the AP continuously updates the image data in several consecutive image frames. As shown in FIG. 9, the AP outputs different image frames B, C, D, E, F and G in series, and continuously transmits the command CMDB to indicate that the image data are updated. As the image data are updated, the display driver circuit interrupts the present display sequence, restarts a new display sequence, and configures these image frames as the active frame of the skip sequence SEQ1, until the AP stops updating the image data.

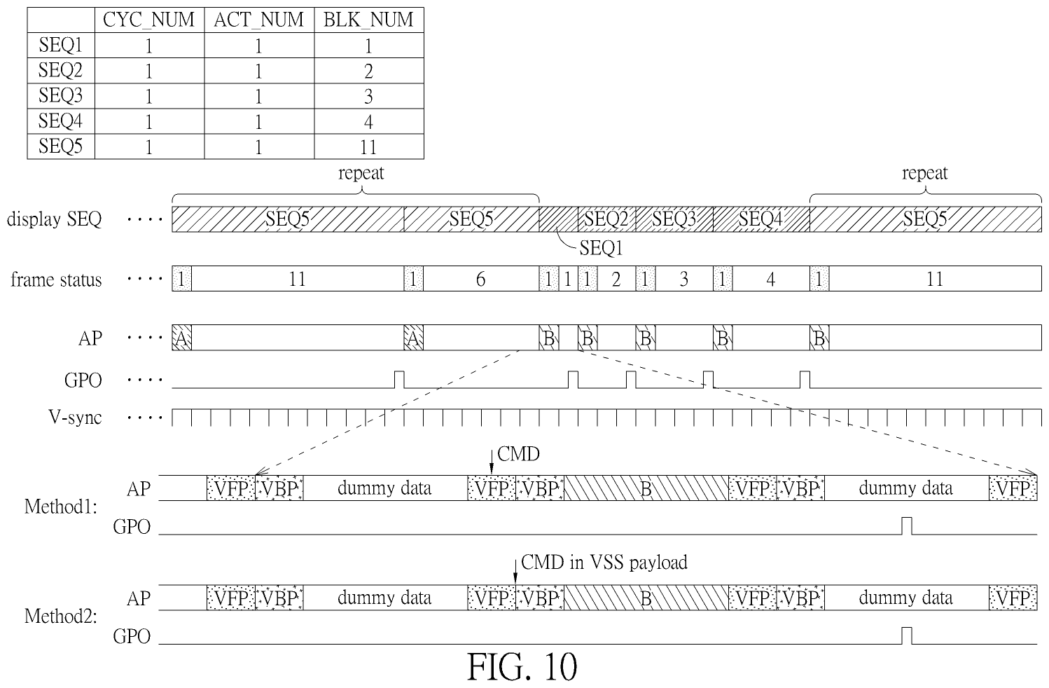

FIG. 10 illustrates an additional timing diagram of the display sequence according to an embodiment of the present invention. The embodiment shown in FIG. 10 is similar to the embodiment shown in FIG. 7, except that the AP transmits the command CMD only when it needs to proactively update the image data. As mentioned above, the AP may determine whether to transmit a command to the display driver circuit to indicate whether the AP is configured to proactively output the image data (Step 606). In this embodiment, the AP may stop transmitting the command CMD when it does not need to output image data, or when the AP outputs the image data identical to those output previously in response to the notification from the display driver circuit.

As shown in FIG. 10, the command CMD for the current image frame (where the image data B are output) may be carried in the VFP of the previous image frame (i.e., Method 1) or the VSS payload of the current image frame (i.e., Method 2). In another embodiment, the command CMD may be transmitted as being indicated by the VSE data type or transmitted through a GPO pin, or delivered to the display driver circuit in any other possible manner.

Another difference between FIG. 10 and FIG. 7 is that the notification of the display driver circuit forwarded through the GPO pin is synchronous to the image data area of the previous image frame in the embodiment of FIG. 10. Further, the image data areas in which no data is included in the embodiment of FIG. 7 are filled with dummy data in the embodiment of FIG. 10. Those skilled in the art should understand that the image data areas in the blanking frames may be filled with dummy data or include no data transmission according to system requirements.

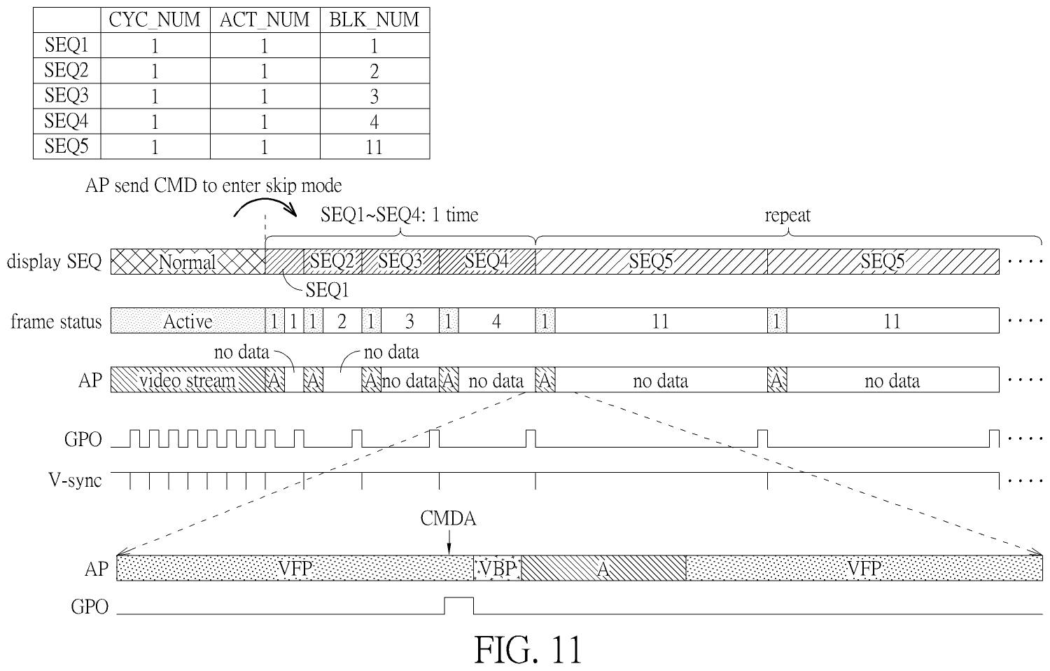

FIG. 11 illustrates still another timing diagram of the display sequence according to an embodiment of the present invention. The embodiment shown in FIG. 11 is similar to the embodiment shown in FIG. 5, except that the timing of the blanking frames in FIG. 11 is implemented in another manner. In detail, as for those blanking frames where the AP does not need to transmit any image data, the timing sequence may be rearranged so that the previous VFP may be extended to the blanking frames. For example, if a present image frame is a blanking frame, the previous image frame may be configured with an extended VFP, which extends to cover the entire present blanking frame, and may last until the appearance of a next active frame.

Please note that the embodiments shown in FIGS. 5, 8, 9 and 11 may also be altered so that the AP transmits the command only when it needs to proactively output the image data. In such a situation, the command CMDA may be omitted. The display driver circuit will know that the image data are not updated by the AP if no related command is received. Also note that the image data area where no data is included in FIGS. 5, 7, 8 and 9 may also be allocated with dummy data as shown in FIG. 10, or the image data area of the blanking frames may be replaced by an extended VFP as shown in FIG. 11.

To sum up, the present invention provides a novel display control method applicable to the display driver circuit and the AP, where the display driver circuit and the AP may negotiate with each other to appropriately control the panel refresh when the display system is operated in the video mode. As for a display panel capable of realizing a low frame rate in the skip mode by refreshing in partial image frames such as the LTPO panel, the AP is requested to output the image data only when the image frame needs to be refreshed. Therefore, the display driver circuit may determine whether to transmit a notification to the AP, to indicate whether the image frame needs to be refreshed based on the display sequence of the skip mode. Sometimes the AP may need to proactively update the image data, and the AP may determine whether to transmit a command to the display driver circuit, to indicate whether the AP needs to proactively output the image data. In an embodiment, the command and/or the notification may be sent through the interface used for delivering image data, and/or may be sent through a GPO pin. As a result, the operations of the AP and the display driver circuit will be well synchronized, so as to refresh the display panel appropriately in the skip mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of display control for a display driver circuit, the display driver circuit being operated in a video mode, the method comprising:
driving a display panel to display a plurality of image frames having a plurality of active frames and a plurality of blanking frames; and
determining whether to transmit a notification to an application processor to indicate whether the application processor needs to output image data according to whether an incoming image frame among the plurality of image frames is one of the plurality of active frames or one of the plurality of blanking frames;
wherein the display panel is refreshed in each of the plurality of active frames, and not refreshed in each of the plurality of blanking frames.

2. The method of claim 1, wherein the step of determining whether to transmit the notification to the application processor to indicate whether the application processor needs to output the image data according to whether the incoming image frame is one of the plurality of active frames or one of the plurality of blanking frames comprises:
transmitting a first notification to the application processor to notify the application processor to output the image data when the incoming image frame is one of the plurality of active frames.

3. The method of claim 2, wherein the step of determining whether to transmit the notification to the application processor to indicate whether the application processor needs to output the image data according to whether the incoming image frame is one of the plurality of active frames or one of the plurality of blanking frames further comprises:
transmitting a second notification different from the first notification to the application processor to notify the application processor to stop outputting the image data when the incoming image frame is one of the plurality of blanking frames.

4. The method of claim 1, further comprising:
stopping transmitting the notification to the application processor when the incoming image frame is one of the plurality of blanking frames.

5. The method of claim 1, wherein the notification is transmitted through an interface between the display driver circuit and the application processor used for delivering the image data.

6. The method of claim 1, wherein the notification is transmitted through a general purpose output (GPO) pin.

7. The method of claim 1, wherein the notification for a first active frame among the plurality of active frames is carried in the first active frame or a previous image frame previous to the first active frame.

8. The method of claim 1, further comprising:
receiving a command from the application processor, wherein the command indicates whether the application processor needs to proactively output the image data.

9. The method of claim 8, wherein the plurality of image frames are allocated to a plurality of skip sequences, each having at least one of the plurality of active frames and at least one of the plurality of blanking frames, and the method further comprises:
interrupting a present skip sequence among the plurality of skip sequences and starting an active frame of a next skip sequence among the plurality of skip sequences when the received command indicates that the application processor needs to proactively output the image data.

10. The method of claim 1, wherein the plurality of image frames are allocated to a plurality of skip sequences according to a skip mode of the display panel, and the method further comprises:
receiving a mode change signal from the application processor; and
controlling the skip mode of the display panel according to the mode change signal.

11. A display driver circuit, configured to be coupled to an application processor and a display panel, the display driver circuit being operated in a video mode and configured to:
drive the display panel to display a plurality of image frames having a plurality of active frames and a plurality of blanking frames; and
determine whether to transmit a notification to the application processor to indicate whether the application processor needs to output image data according to whether an incoming image frame is one of the plurality of active frames or one of the plurality of blanking frames;
wherein the display panel is refreshed in each of the plurality of active frames, and not refreshed in each of the plurality of blanking frames.

12. A method of display control for an application processor, the application processor being configured to control a display driver circuit operated in a video mode, the method comprising:
providing a plurality of image frames for the display driver circuit to be displayed on a display panel;
outputting first image data for a first image frame among the plurality of image frames to the display driver circuit; and
after outputting the first image data, determining whether to transmit a command to the display driver circuit for a second image frame among the plurality of image frames, to indicate whether the application processor is configured to proactively output second image data for the second image frame.

13. The method of claim 12, wherein the step of determining whether to transmit the command to the display driver circuit for the second image frame among the plurality of image frames to indicate whether the application processor is configured to proactively output the second image data for the second image frame comprises:
transmitting a first command to the display driver circuit for the second image frame when the application processor is configured to output the second image data for the second image frame, wherein the second image data are different from the first image data.

14. The method of claim 13, wherein the step of determining whether to transmit the command to the display driver circuit for the second image frame among the plurality of image frames to indicate whether the application processor is configured to proactively output the second image data for the second image frame further comprises:
transmitting a second command different from the first command to the display driver circuit for the second image frame when the application processor is configured to output the second image data for the second image frame, wherein the second image data are identical to the first image data.

15. The method of claim 13, wherein the step of determining whether to transmit the command to the display driver circuit for the second image frame among the plurality of image frames to indicate whether the application processor is configured to proactively output the second image data for the second image frame further comprises:
transmitting a second command different from the first command to the display driver circuit for the second image frame when the application processor is configured to not output any image data for the second image frame.

16. The method of claim 12, wherein the step of determining whether to transmit the command to the display driver circuit for the second image frame among the plurality of image frames to indicate whether the application processor is configured to proactively output the second image data for the second image frame comprises:
stopping transmitting the command to the display driver circuit for the second image frame when the application processor is configured to output the second image data for the third image frame, wherein the second image data are identical to the first image data.

17. The method of claim 12, wherein the step of determining whether to transmit the command to the display driver circuit for the second image frame among the plurality of image frames to indicate whether the application processor is configured to proactively output the second image data for the second image frame comprises:
stopping transmitting the command to the display driver circuit for the second image frame when the application processor is configured to not output any image data for the second image frame.

18. The method of claim 12, wherein the command is transmitted through an interface between the display driver circuit and the application processor used for delivering the image data.

19. The method of claim 12, wherein the command is transmitted through a general purpose output (GPO) pin.

20. The method of claim 12, wherein the command for the second image frame is carried in the second image frame or a previous image frame previous to the second image frame.

21. The method of claim 12, further comprising:
receiving a notification from the display driver circuit, wherein the notification indicates whether the display panel needs to be refreshed.

22. The method of claim 12, wherein the plurality of image frames are allocated to a plurality of skip sequences, each having at least one active frame and at least one blanking frame, and wherein the command instructs the display driver circuit to interrupt a present skip sequence among the plurality of skip sequences and start an active frame of a next skip sequence among the plurality of skip sequences when the command indicates that the application processor is configured to proactively output the second image data.

23. The method of claim 12, wherein the plurality of image frames are allocated to a plurality of skip sequences according to a skip mode of the display panel, and the method further comprises:
transmitting a mode change signal to the display driver circuit, to instruct the display driver circuit to control the skip mode of the display panel.

24. An application processor, configured to be coupled to a display driver circuit and a display panel, the display driver circuit being operated in a video mode, and the application processor being configured to:
provide a plurality of image frames for the display driver circuit to be displayed on the display panel;
output first image data for a first image frame among the plurality of image frames to the display driver circuit; and
after the first image data are output, determine whether to transmit a command to the display driver circuit for a second image frame among the plurality of image frames, to indicate whether the application processor is configured to proactively output second image data for the second image frame.
